(19) United States
(12) Patent Application Publication
(10) Pub. No.: US 2024/0021842 A1
(43) Pub. Date: Jan. 18, 2024

(54) CATALYST

(71) Applicant: TOYOTA JIDOSHA KABUSHIKI KAISHA, Toyota-shi (JP)

(72) Inventor: Keiichi OKUBO, Susono-shi (JP)

(21) Appl. No.: 18/350,856

(22) Filed: Jul. 12, 2023

(30) Foreign Application Priority Data
Jul. 15, 2022 (JP) 2022-114005

(51) Int. Cl. H01M 4/86; H01M 4/92

(52) U.S. Cl. CPC H01M 4/8668; H01M 4/921; H01M 4/925; H01M 2004/8689

(57) ABSTRACT

A catalyst comprising: metal particles having an oxygen reducing activity; an additive having a basic functional group; and a binder having an acidic functional group, wherein the additive is at least one organic nitrogen compound, and a ratio (base point amount/acid point amount) of the total base functional group amount of the additive to the total acidic functional group amount of the binder is greater than 0 and less than or equal to 6.82.

### CROSS-REFERENCE TO RELATED APPLICATION

This application claims priority to Japanese Patent Application No. 2022-114005 filed on Jul. 15, 2022, incorporated herein by reference in its entirety.

### BACKGROUND

### 1. Technical Field

The present disclosure relates to a catalyst.

### 2. Description of Related Art

Various studies have been carried out regarding catalysts for electrochemical oxygen reduction.
WO 2019/221156 discloses an electrochemical oxygen reduction catalyst including a platinum-containing nanoparticle, and at least one type selected from a group consisting of a melamine compound, a thiocyanuric acid compound, and a polymer in which the melamine compound or the thiocyanuric acid compound serves as a monomer.
WO 2021/090746 discloses an electrochemical oxygen reduction catalyst that includes a platinum-containing nanoparticle, and at least one type selected from a group consisting a specific polymer in which a melamine compound serves as a monomer and a specific melamine compound. The electrochemical oxygen reduction catalyst has a high durability at 70-85° C.

### SUMMARY

When an organic nitrogen compound is added as an additive to a catalyst having oxygen reduction activity to improve a catalyst performance, cracking of a catalyst layer may occur.

The present disclosure has been made in view of the above circumstances, and it is a main object of the present disclosure to provide a catalyst that includes an organic nitrogen compound and that can suppress cracking of a catalyst layer from occurring.

The present disclosure provides a catalyst. The catalyst includes a metal particle having an oxygen reduction activity, an additive having a basic functional group, and a binder having an acidic functional group.

In the catalyst, the additive is at least one organic nitrogen compound, and a ratio (base point amount/acid point amount) of a total base functional group amount of the additive to a total acid functional group amount of the binder is greater than zero and equal to or less than 6.82.

In the catalyst according the present disclosure, the organic nitrogen compound may be a monomer represented by Formula (1) described below, or a polymer that contains at least a part of the monomer.

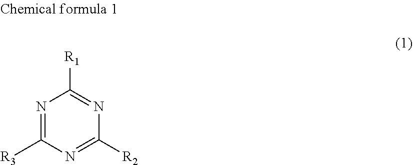

In Formula (1), R₁, R₂, R₃ are each a hydrogen atom, a halogen atom, or one kind of a functional group selected from a group of functional groups consisting of a nitrile group, an amido group, an imine group, an amino group, a thiol group, a hydroxyl group, a sulfo group, a carboxylic acid group, a phosphoric acid group, a ketone group, an aldehyde group, an ester group, an alkoxy group, a phenol group, a cyclopentyl group, a cyclohexyl group, an alkylamino group having 1 to 10 carbon atoms, an alkylsulfonic acid group having 1 to 10 carbon atoms, a perfluoroalkyl group having 1 to 10 carbon atoms, and an alkyl group having 1 to 10 carbon atoms, an alkenylamino group having 1 to 10 carbon atoms, an alkenylsulfonic acid group having 1 to 10 carbon atoms, an perfluoroalkenyl group having 1 to 10 carbon atoms, and an alkenyl group having 1 to 10 carbon atoms, and the functional groups may each have, in a molecular chain, at least one kind selected from a group consisting of at least one kind of functional group selected from the group of functional groups, an aromatic ring, a heterocyclic ring, an oxygen atom, a sulfur atom, a nitrogen atom, a fluorine atom, a chlorine atom, a bromine atom, an iodine atom, and a hydrogen atom.

In the catalyst of the present disclosure, the metal particle may be at least one kind selected from a group consisting of a platinum particle, a platinum alloy particle, and a composite particle containing platinum.

The catalyst of the present disclosure may further include a carrier, and the metal particle may be supported by the carrier.

In the catalyst of the present disclosure, a weight of the additive with respect to a weight of the carrier may be equal to or more than 0.0100 and equal to or less than 0.150.

In the catalyst of the present disclosure, a weight of the binder with respect to a weight of the carrier may be equal to or more than 0.700 and equal to or less than 1.15.

In the catalyst of the present disclosure,
the binder may be a perfluorocarbon sulfonate polymer, and an equivalent weight per mole of the acidic functional group of the binder may be equal to or more than 600 g/mol and equal to or less than 1100 g/mol.

In the catalyst of the present disclosure,
the additive may be oleylamine, melamine, or a polymer of melamine, and an equivalent weight of the additive per mole of the basic functional group may be equal to or more than 21.0 g/mol and equal to or less than 267 g/mol.

The present disclosure provides an air electrode for a fuel cell or a metal-air cell. The air electrode for the fuel cell or the metal-air cell includes the catalyst.

The present disclosure provides a fuel cell. The fuel cell includes the air electrode as a cathode.

In the present disclosure, a metal-air battery is provided, and the metal-air battery includes the air electrode as a cathode.

The present disclosure can provide a catalyst that includes an organic nitrogen compound and that can suppress cracking of a catalyst layer from occurring.

### DETAILED DESCRIPTION OF EMBODIMENTS

Embodiments according to the present disclosure will be described below. It should be noted that matters other than those specifically mentioned in the present specification and necessary for the practice of the present disclosure (for example, a general configuration of a catalyst that does not characterize the present disclosure and a manufacturing process) can be understood as design matters of a person skilled in the art based on the prior art in the field. The present disclosure can be implemented based on the content disclosed in this specification and common general technical knowledge in the field. In the present specification, “from” indicating a numerical range is used in a sense including numerical values described before and after the numerical range as a lower limit value and an upper limit value.

Any combination of the upper and lower limits in the numerical range can be adopted.

### 1. Catalyst

The present disclosure includes metal particles having oxygen reduction activity, an additive having a basic functional group, and a binder having an acidic functional group.

The additive is at least one organic nitrogen compound,
A catalyst is provided, wherein a ratio (base point amount/acid point amount) of the total base functional group amount of the additive to the total acid functional group amount of the binder is greater than 0 and less than or equal to 6.82.

Cracking of the catalyst layer directly leads to a problem that the durability of the product is lowered, the yield of the product is lowered, and the membrane-electrode assembly cannot be formed. The cracking of the catalyst layer is because the organic nitrogen compound as an additive is bonded to a binder having an acidic functional group, thereby inhibiting the catalyst layer binding function of the binder. The organic nitrogen compound has a basic functional group, and the binder has an acidic functional group. Acid-base interactions form a bond between them. The binder originally has a function of preventing cracking of the catalyst layer by interacting with a metal contained in the catalyst and a support thereof, and promoting binding between primary particles and secondary particles of the catalyst. The addition of organic nitrogen compounds inhibits the function of the binder and induces cracking of the catalyst layer.

In the catalyst of the present disclosure, cracking of the catalyst layer can be suppressed by controlling the ratio of the total amount of acidic functional groups and the total amount of base functional groups contained in the catalyst, the yield of the product can be increased, and the durability of the product can be increased.

The catalyst of the present disclosure includes metal particles having oxygen reduction activity, an additive having a basic functional group, and a binder having an acidic functional group.

The additive has a basic functional group. The additive is at least one organic nitrogen compound.

The organic nitrogen compound may be a compound having a nitrogen equivalent weight representing dry weight per mole of nitrogen of 20 to 270 g·eq⁻¹, or may be a compound having a 70 g·eq⁻¹ of 20.
The nitrogen equivalent can be calculated from the following equation: In the case of a polymer, the nitrogen equivalent weight of the monomer is regarded as the nitrogen equivalent weight of the polymer.

Nitrogen equivalent weight (g·eq⁻¹)=molecular weight (g/mol)/molecular weight of nitrogen material (mol_{N}/mol)

The organic nitrogen compound may be a compound having an amine functional group, a compound having a pyridine-type nitrogen, or a compound containing a triazine ring. The organic nitrogen compound may be a monomer represented by the following formula (1) or a polymer containing the monomer at least in part.

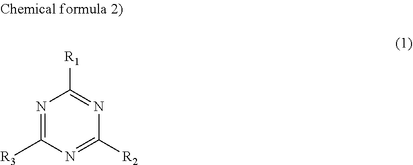

In Formula (1), R₁, R₂, R₃ are each a hydrogen atom, a halogen atom, or
one kind of a functional group selected from a group of functional groups consisting of a nitrile group, an amido group, an imine group, an amino group, a thiol group, a hydroxyl group, a sulfo group, a carboxylic acid group, a phosphoric acid group, a ketone group, an aldehyde group, an ester group, an alkoxy group, a phenol group, a cyclopentyl group, a cyclohexyl group, an alkylamino group having 1 to 10 carbon atoms, an alkylsulfonic acid group having 1 to 10 carbon atoms, a perfluoroalkyl group having 1 to 10 carbon atoms, and an alkyl group having 1 to 10 carbon atoms, an alkenylamino group having 1 to 10 carbon atoms, an alkenylsulfonic acid group having 1 to 10 carbon atoms, an perfluoroalkenyl group having 1 to 10 carbon atoms, and an alkenyl group having 1 to 10 carbon atoms, and the functional groups may have at least one kind selected from a group consisting of at least one kind of functional group selected from the group of functional groups, an aromatic ring, a heterocyclic ring, an oxygen atom, a sulfur atom, a nitrogen atom, a fluorine atom, a chlorine atom, a bromine atom, an iodine atom, and a hydrogen atom.

In Formula (1), R₁, R₂, R₃ may be a primary amine, a secondary amine, a tertiary amine, or a quaternary ammonium cation, respectively.

Examples of the organic nitrogen compound include melamine compounds (nitrogen equivalent 21 g·eq⁻¹), thiocyanuric acid compounds (nitrogen equivalent 59 g·eq⁻¹), cyanuric acid compounds (nitrogen equivalent 34 g·eq⁻¹), oleylamine (nitrogen equivalent 267 g·eq⁻¹), tetradecylamine (nitrogen equivalent 213 g·eq⁻¹), 2,4,6-Tris[bis(methoxymetyl)amino]-1,3,5-triazine (nitrogen-equivalent 65 g·eq⁻¹), 6-(Dibutylamino)-1,3,5-triazine-2,4-dithiol (nitrogen-equivalent 68 g·eq⁻¹), 2,4-Diamino-6-butylamino-1,3,5-triazine (nitrogen-equivalent 30 g·eq⁻¹, 2,4,6-Tris(pentafluoroethyl)-1,3,5-triazine (nitrogen-equivalent 145 g·eq⁻¹), a polymer comprising these monomers, and Poly(melamine-co-formaldehyde)methylated (nitrogen-equivalent 20 to 40 g·eq⁻¹, and Poly(melamine-co-formaldehyde)isobutylated (nitrogen-equivalent 20 to 40 g·eq⁻¹ or the like may be used. In addition, two or more kinds of the aforementioned additives may be included.

The melamine compound may be melamine, a derivative of melamine, or the like. The thiocyanuric acid compound may be thiocyanuric acid, a derivative of thiocyanuric acid, or the like. The cyanuric acid compound may be cyanuric acid, a derivative of cyanuric acid, or the like.

Examples of the polymer containing a melamine compound, a thiocyanuric acid compound, or a cyanuric acid compound as a monomer include a melamine resin having a melamine compound, a thiocyanuric acid compound, or a cyanuric acid compound as described above in the main chain of the repeating unit, a thiocyanuric acid resin, and a cyanuric acid resin. The additive may be oleylamine, 1,3,5-triazine-2,4,6-triamine, or a polymer thereof, among those described above. In the case of the polymer, since it is less likely to desorb after being adsorbed on the metal particles than in the case of the monomer, the adsorption stability is improved. The polymer may have a degree of polymerization ranging from 1 to 10000.

The equivalent weight of the additive per mole of basic functional group may be greater than or equal to 21.0 g/mol and less than or equal to 267 g/mol.

The metal particles may be any metal having oxygen reduction activity (oxygen reduction catalytic activity), and examples thereof include metals such as platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and two or more of these metals may be used. The metal may be an oxide, a nitride, a sulfide, a phosphide, or the like. The metal particles may be at least one selected from the group consisting of platinum particles, platinum alloy particles, and composite particles containing platinum.

Metals other than platinum included in the platinum alloy and the composite particles containing platinum include metals such as ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and may contain two or more of these metals.
The elemental ratio of the metal other than platinum in the platinum alloy is not particularly limited, and may be 0.11 to 50 atm %.
The particle size of the metallic particles is not particularly limited, and may be 1 to 100 nm.

In the present disclosure, the particle size of the particles is an average crystallite size measured by an X-ray diffraction method.

The particle diameter of the particles may be 100 to 1000 particles measured by an electron microscope, and the average value thereof may be the average particle diameter of the particles. In the present disclosure, the particle size was measured by the above two methods.

The catalyst of the present disclosure may include a support such as carbon and an oxide.

The metal particles are supported on a support.
The method of supporting the metal particles on the support is not particularly limited, and a conventionally known method can be appropriately employed.
The carrier may be a primary particle or a secondary particle.
The particle size of the primary particles of the carrier may be, for example, from 5 to 500 nm.
The metal supporting ratio of the metal particles supported on the support is not particularly limited, and may be 1 to 60%, or 18 to 48%.
The support may be conductive carbon, an oxide, a mixture containing at least two of them, or the like.
The carbon may be carbon black (such as acetylene black, ketjen black, channel black, roller black, disk black, oil furnace black, gas furnace black, lamp black, thermal black, and VULCAN based carbon), activated carbon, graphite, glassy carbon, graphite, graphene, carbon fiber, carbon nanotube, carbon nitride, sulfurized carbon, and phosphated carbon, or mixtures containing at least two of these.
The oxide may be titanium oxide, niobium oxide, tin oxide, tungsten oxide, molybdenum oxide, or a mixture containing at least two of them.

The binder may be one having an acidic functional group. The binder may be a polyelectrolyte. The polyelectrolyte may be referred to as an electrolyte, an ionomer, or an ionomer. In the present disclosure, a binder is described below. The binder may have sulfonic acid, phosphoric acid, and the like as the acidic functional group. The binder may be a perfluorocarbon sulfonic acid polymer, an anion exchange polymer, or a polymer based on polyether ether ketone, polybenzimidazole, and the like.

The equivalent weight of the binder per mole of the acidic functional group may be 600 g/mol or more and 1100 g/mol or less.

### Base Point Amount/Acid Point Amount

In the catalyst of the present disclosure, the ratio (base point amount/acid point amount) of the total base functional group amount of the additive to the total acid functional group amount of the binder is greater than 0 and less than or equal to 6.82.

The ratio of base point to acid point is defined as (total amount of basic functional groups in the additive)/(total amount of acidic functional groups in the binder).
The base point amount/acid point amount may be calculated from the following equation.

Base point amount/acid point amount(−)=(weight ratio of additive to carrier weight(−)/equivalent weight per mole of basic functional group of additive (g/mol))/(weight of binder to carrier weight(−)/equivalent weight per mole of acidic functional group of binder (g/mol))

The type of the basic functional group serving as the base point is not particularly limited, and may be an amine group such as an aliphatic amine group and an aromatic amine group, a pyridine group, an imine group, a nitrile group, a pyrrole group, or the like.
The type of the acidic functional group to be the acid point is not particularly limited, and may be a sulfonic acid group, a phosphoric acid group, or the like.

### Weight of Additive Relative to the Weight of Carrier

In the catalyst of the present disclosure, the weight of the additive relative to the weight of the support may be 0.0100 or more and 0.150 or less.

Additive weight relative to carrier weight is defined as (additive weight)/(carrier weight).

### Binder Weight Relative to Carrier Weight

In the catalyst of the present disclosure, the weight of the binder relative to the weight of the support may be 0.700 or more and 1.15 or less.

The binder weight relative to the carrier weight is defined as (binder weight)/(carrier weight).

### Additive Weight Evaluation Method

Examples of the method for evaluating the weight of the additive included in the catalyst include a method of measuring the nitrogen content by CHN elemental spectrometry, a method of extracting the additive from the catalyst and directly measuring the additive, and the like.

A method of measuring nitrogen content by CHN elemental spectrometry is a method of measuring the amounts of carbon, hydrogen, and nitrogen atoms contained in a sample by burning the sample with oxygen for a certain period of time and then quantifying the generated carbon dioxide, water, and nitrogen oxides, respectively. It is possible to evaluate the amount of the additive by comparing the amount of nitrogen in the sample before and after the introduction of the additive.
A method of extracting an additive from an oxygen reduction catalyst and directly measuring the additive is a method of quantitatively and quantitatively analyzing the additive after extracting the additive with a solvent that dissolves the additive contained in the catalyst. Examples of analytical methods include chromatographic, ultraviolet-visible spectroscopy (UV-vis), infrared spectroscopy (IR), and nuclear magnetic resonance (NMR).

### Evaluation Method of Metal Particle Weight, Carrier Weight, and Binder Weight

Methods for evaluating the weight of the metallic particles, the weight of the support, and the weight of the binder included in the catalyst of the present disclosure include thermogravimetric analysis (TG), high-frequency inductively coupled plasma-emission spectroscopy (ICP), and the like.

Thermogravimetric spectrometry (TG) is a method of measuring the weight when the gas-atmosphere, temperature, and the like are changed. This is a measurement method in which moisture, a conductive carrier, a polymer having an ion exchange group, and an impurity are burned at an elevated temperature, and then the remaining weight is used as the weight of the metal particles.
High-frequency Inductively Coupled Plasma Emission Spectroscopy (ICP) is a technique for qualitatively and quantitatively quantifying contained elements from the wavelength and intensity of an emission line emitted by atoms excited by a plasma. It is possible to calculate the weight of an arbitrary substance by controlling the measurement temperature and the gas atmosphere.
It is possible to directly quantify the weight of the metal particles, the weight of the support, and the weight of the binder contained in the catalyst.

The catalyst of the present disclosure may be for a fuel cell or a metal-air cell. The catalyst of the present disclosure may be used for a cathode of a fuel cell, an anode of a fuel cell, or an air electrode of a metal-air cell. In addition, the catalyst of the present disclosure may be used for an anode for water electrolysis, which is a reverse reaction of a fuel cell, or may be used for a cathode for water electrolysis, may be used for an anode for CO₂ reduction, or may be used for a cathode for CO₂ reduction.

The shape of the catalyst of the present disclosure may be layered. That is, the catalyst of the present disclosure may be a catalyst layer.

Examples of the catalyst layer forming method include the following methods.

### Catalyst Ink Preparation Process

First, a predetermined amount of a carrier (metal particle-supported carrier) carrying metal particles, a binder, an additive, and a solvent is charged into a container, and these are stirred using a stirrer to prepare a catalyst ink.

The solvent species is not particularly limited, and any liquid may be used, and may be water, an alcohol, a mixed solution of at least one alcohol and water, or the like.
Examples of the alcohol include methanol, diacetone alcohol, ethanol, 1-propanol, 2-propanol, tert-butyl alcohol, ethylene glycol, and propylene glycol.
Examples of the agitator include a ball mill such as an ultrasonic homogenizer, a jet mill, and a bead mill, a high-shear mill, and a fill mix. The stirring conditions such as the stirring speed, the stirring time, and the number of revolutions are not particularly limited, and can be appropriately set.
Thereafter, a vacuum defoaming treatment is performed, and the mixture is allowed to stand for 1 day. The time to stand is not limited, and can be arbitrarily set. It is also possible to use it without standing. Further, the vacuum defoaming treatment may be performed again.

### Catalyst Ink Coating Process

The prepared catalyst ink is coated on a substrate, and the solvent is removed after the coating. For example, the catalyst ink is coated on the substrate, the catalyst ink after the coating is heated, and the solvent is dried and removed.

Examples of the base material include polytetrafluoroethylene (PTFE), an electrolyte membrane having an ion-exchange group, a gas diffusion layer (GDL) composed of a carbon fiber or a metal fiber, and a gas diffusion layer composed of a carbon fiber or a metal fiber having a microporous layer (MPL).
The coating method may be any method capable of uniformly coating the catalyst ink on the substrate, and examples thereof include a die coating method, a spin coating method, a screen printing method, a doctor blade method, a squeegee method, a spray coating method, and an applicator method. The heating rate and the heating time can be appropriately set depending on the solvent species and the like. Further, the removal rate may be increased by degassing simultaneously with warming.
It is also possible to change the coating film thickness and the metal particle content.
The coating thickness may be from 5 to 30 micrometers, and may be applied such that the platinum content satisfies 0.6 mgcm⁻² from 0.1.

### 2. Air Electrode

In the present disclosure, an air electrode for a fuel cell or a metal-air cell including the catalyst is provided.

The cathode of the present disclosure includes the catalyst of the present disclosure. The cathode of the present disclosure may be a catalyst layer of the present disclosure.
The cathode of the present disclosure may be for a fuel cell or a metal-air cell.

### 3. Fuel Cell

In the present disclosure, a fuel cell having the air electrode as a cathode is provided.

The fuel cell of the present disclosure has an air electrode of the present disclosure as a cathode (cathode catalyst layer).

In the fuel cell of the present disclosure, a configuration of a conventionally known fuel cell other than having the air electrode of the present disclosure as a cathode can be appropriately adopted. The fuel cell of the present disclosure may have an anode comprising the catalyst of the present disclosure. The fuel cell of the present disclosure may have the catalyst layer of the present disclosure as an anode (anode catalyst layer).
Since the fuel cell of the present disclosure uses the air electrode containing the catalyst of the present disclosure having less cracks as a cathode, the power generation performance and durability performance of the fuel cell can be improved.

### 4. Metal-Air Battery

In the present disclosure, a metal-air battery having the air electrode as a cathode is provided.

The metal-air battery of the present disclosure has the air electrode of the present disclosure as a cathode.

In the metal-air battery of the present disclosure, a configuration of a conventionally known metal-air battery other than having the air electrode of the present disclosure as a cathode can be appropriately adopted.
Since the metal-air battery of the present disclosure uses the air electrode containing the catalyst of the present disclosure having less cracks as a cathode, the power generation performance and durability performance of the metal-air battery can be improved.

### Example 1

Platinum-cobalt alloy particles (4 nm from metal particle diameter 3) as metal particles, 1,3,5-triazine-2,4,6-triamine (melamine, Fujifilm Wako Pure Chemical Industries, Ltd.) as an additive, carbon (acetylene black) as a carrier, and perfluorocarbon sulfonic acid polymer as a binder were prepared, and a layer (catalyst layer) made of a catalyst containing these was formed by the following methods.

### Catalyst Layer Forming Method

A carrier (metal particle-supported carrier, metal-supported ratio 48 wt %), a binder, an additive, water as a solvent, and diacetone alcohol were charged in a predetermined amount in a container, and these were stirred at a 300 rpm for a total of 4 hours using a bead mill to prepare a catalytic ink.

The catalyst ink was vacuum defoamed and allowed to stand for 1 day.
Thereafter, the catalyst ink was subjected to vacuum defoaming again.
The prepared catalyst ink was coated on polytetrafluoroethylene (PTFE) as a base material by a die coating method, and the catalyst ink after the coating was heated, and the solvents were dried and removed to form a catalyst layer. The coating was applied so that the content of platinum in the catalytic bed was 0.20 mgcm⁻².
The formed catalyst layer was observed at 40× and 500× magnifications with a microscope. Note that it is also possible to change the magnification.
From the area ratio in the photographed image observed at 500×, the crack area ratio (%) of the catalyst layer was evaluated.
The crack area 2% or less is A, the crack area 10% or less is B, the crack area larger than 10% is C, the case where the catalyst-layer formation is not possible was D. The results are given in Table 1.

### Base Point Amount/Acid Point Amount

The ratio (base point amount/acid point amount) of the total base functional group amount of the additive to the total acid functional group amount of the binder was calculated from the following formula. The ratio of the base point amount to the acid point amount, the weight ratio of the additive to the weight of the carrier, and the weight ratio of the binder to the weight of the carrier are shown in Table 1.

Base point amount/acid point amount(−)=(weight ratio of additive to carrier weight(−)/equivalent weight per mole of basic functional group of additive (g/mol))/(weight of binder to carrier weight(−)/equivalent weight per mole of acidic functional group of binder (g/mol))

### Examples 2 to 20 and Comparative Examples 1 to 14

A catalyst layer was formed under the same conditions as in Example 1, except that at least one of the base point amount/acid point amount, the additive weight ratio to the carrier weight, the equivalent mass per mole of the basic functional group of the additive, the binder weight to the carrier weight, and the equivalent mass per mole of the acidic functional group of the binder was changed as shown in Tables 1 to 9 so that the base point amount/acid point amount became the values shown in Tables 1 to 9, and the crack area ratio (%) of the catalyst layer was evaluated. In Examples 13 to 14, oleylamine was used as an additive. In Comparative Examples 6 to 14, no additive was used. The results are shown in Tables 1 to 9.

TABLE 1

| | Example 1 | Example 2 | Example 3 | Example 4 |
|---|---|---|---|---|
| Binder weight | 0.700 | 0.700 | 0.850 | 0.850 |
| (—) relative to | | | | |
| carrier weight | | | | |
| Equivalent | 1100 | 1100 | 1100 | 1100 |
| weight per one | | | | |
| mole of acid | | | | |
| functional | | | | |
| group of binder | | | | |
| (gmol⁻¹) | | | | |
| Additive | 1,3,5-triazine- | 1,3,5-triazine- | 1,3,5-triazine- | 1,3,5-triazine- |
| species | 2,4,6-triamine | 2,4,6-triamine | 2,4,6-triamine | 2,4,6-triamine |
| Additive weight | 0.0100 | 0.0500 | 0.0100 | 0.0500 |
| (—) relative to | | | | |
| carrier weight | | | | |
| Equivalent | 21.0 | 21.0 | 21.0 | 21.0 |
| weight per one | | | | |
| mole of basic | | | | |
| functional | | | | |
| group of | | | | |
| additive | | | | |
| (gmol⁻¹) | | | | |
| Base point | 0.75 | 3.74 | 0.62 | 3.08 |
| amount/Acid | | | | |
| point amount | | | | |
| (—) | | | | |
| Evaluation of | A | A | A | A |
| cracked area of | | | | |
| catalyst layer | | | | |

TABLE 2

| | Example 5 | Example 6 | Example 7 | Example 8 |
|---|---|---|---|---|
| Binder weight | 0.850 | 1.00 | 1.00 | 1.00 |
| (—) relative to | | | | |
| carrier weight | | | | |
| Equivalent | 1100 | 1100 | 1100 | 1100 |
| weight per one | | | | |
| mole of acid | | | | |
| functional | | | | |
| group of binder | | | | |
| (gmol⁻¹) | | | | |
| Additive | 1,3,5- | 1,3,5- | 1,3,5- | 1,3,5- |
| species | triazine- | triazine- | triazine- | triazine- |
| | 2,4,6- | 2,4,6- | 2,4,6- | 2,4,6- |
| | triamine | triamine | triamine | triamine |
| Additive weight | 0.100 | 0.010 | 0.050 | 0.100 |
| (—) relative to | | | | |
| carrier weight | | | | |
| Equivalent | 21.0 | 21.0 | 21.0 | 21.0 |
| weight per one | | | | |
| mole of basic | | | | |
| functional group | | | | |
| of additive | | | | |
| (gmol⁻¹) | | | | |
| Base point | 6.16 | 0.52 | 2.62 | 5.23 |
| amount/Acid | | | | |
| point amount | | | | |
| (—) | | | | |
| Evaluation of | A | A | A | A |
| cracked area of | | | | |
| catalyst layer | | | | |

TABLE 3

| | Example 9 | Example 10 | Example 11 | Example 12 |
|---|---|---|---|---|
| Binder weight | 1.15 | 1.15 | 1.15 | 1.15 |
| (—) relative to | | | | |
| carrier weight | | | | |
| Equivalent | 1100 | 1100 | 1100 | 1100 |
| weight per one | | | | |
| mole of acid | | | | |
| functional | | | | |
| group of binder | | | | |
| (gmol⁻¹) | | | | |
| Additive | 1,3,5- | 1,3,5- | 1,3,5- | 1,3,5- |
| species | triazine- | triazine- | triazine- | triazine- |
| | 2,4,6- | 2,4,6- | 2,4,6- | 2,4,6- |
| | triamine | triamine | triamine | triamine |
| Additive weight | 0.0100 | 0.0500 | 0.100 | 0.150 |
| (—) relative to | | | | |
| carrier weight | | | | |
| Equivalent | 21.0 | 21.0 | 21.0 | 21.0 |
| weight per one | | | | |
| mole of basic | | | | |
| functional group | | | | |
| of additive | | | | |
| (gmol⁻¹) | | | | |
| Base point | 0.46 | 2.28 | 4.55 | 6.83 |
| amount/Acid | | | | |
| point amount | | | | |
| (—) | | | | |
| Evaluation of | A | A | A | A |
| cracked area of | | | | |
| catalyst layer | | | | |

TABLE 4

| | Example 13 | Example 14 | Example 15 | Example 16 |
|---|---|---|---|---|
| Binder weight | 0.850 | 0.850 | 0.850 | 0.700 |
| (—) relative to | | | | |
| carrier weight | | | | |
| Equivalent | 1100 | 1100 | 800 | 600 |
| weight per one | | | | |
| mole of acid | | | | |
| functional | | | | |
| group of binder | | | | |
| (gmol⁻¹) | | | | |
| Additive | Oleylamine | Oleylamine | 1,3,5-triazine- | 1,3,5-triazine- |
| species | | | 2,4,6-triamine | 2,4,6-triamine |
| Additive weight | 0.100 | 0.150 | 0.050 | 0.100 |
| (—) relative to | | | | |
| carrier weight | | | | |
| Equivalent | 267 | 267 | 21.0 | 21.0 |
| weight per one | | | | |
| mole of basic | | | | |
| functional | | | | |
| group of | | | | |
| additive | | | | |
| (gmol⁻¹) | | | | |
| Base point | 0.48 | 0.73 | 2.24 | 4.08 |
| amount/Acid | | | | |
| point amount | | | | |
| (—) | | | | |
| Evaluation of | A | A | A | A |
| cracked area of | | | | |
| catalyst layer | | | | |

TABLE 5

| | Example 17 | Example 18 | Example 19 | Example 20 |
|---|---|---|---|---|
| Binder weight | 0.85 | 0.85 | 0.85 | 0.85 |
| (—) relative to | | | | |
| carrier weight | | | | |
| Equivalent | 600 | 600 | 600 | 600 |
| weight per one | | | | |
| mole of acid | | | | |
| functional | | | | |
| group of binder | | | | |
| (gmol⁻¹) | | | | |
| Additive | 1,3,5-triazine- | 1,3,5-triazine- | 1,3,5-triazine- | 1,3,5-triazine- |
| species | 2,4,6-triamine | 2,4,6-triamine | 2,4,6-triamine | 2,4,6-triamine |
| Additive weight | 0.150 | 0.100 | 0.0500 | 0.0100 |
| (—) relative to | | | | |
| carrier weight | | | | |
| Equivalent | 21.0 | 21.0 | 21.0 | 21.0 |
| weight per one | | | | |
| mole of basic | | | | |
| functional | | | | |
| group of | | | | |
| additive | | | | |
| (gmol⁻¹) | | | | |
| Base point | 5.04 | 3.36 | 1.68 | 0.34 |
| amount/Acid | | | | |
| point amount | | | | |
| (—) | | | | |
| Evaluation of | A | A | A | A |
| cracked area of | | | | |
| catalyst layer | | | | |

TABLE 6

| | Comparative | Comparative | Comparative | Comparative |
|---|---|---|---|---|
| | Example 1 | Example 2 | Example 3 | Example 4 |
| Binder weight | 0.700 | 0.700 | 0.850 | 1.00 |
| (—) relative to | | | | |
| carrier weight | | | | |
| Equivalent | 1100 | 1100 | 1100 | 1100 |
| weight per one | | | | |
| mole of acid | | | | |
| functional | | | | |
| group of binder | | | | |
| (gmol⁻¹) | | | | |
| Additive | 1,3,5-triazine- | 1,3,5-triazine- | 1,3,5-triazine- | 1,3,5-triazine- |
| species | 2,4,6-triamine | 2,4,6-triamine | 2,4,6-triamine | 2,4,6-triamine |
| Additive weight | 0.100 | 0.150 | 0.150 | 0.150 |
| (—) relative to | | | | |
| carrier weight | | | | |
| Equivalent | 21.0 | 21.0 | 21.0 | 21.0 |
| weight per one | | | | |
| mole of basic | | | | |
| functional | | | | |
| group of | | | | |
| additive | | | | |
| (gmol⁻¹) | | | | |
| Base point | 7.48 | 11.21 | 9.23 | 7.85 |
| amount/Acid | | | | |
| point amount | | | | |
| (—) | | | | |
| Evaluation of | C | D | D | C |
| cracked area of | | | | |
| catalyst layer | | | | |

TABLE 7

| | Comparative | Comparative |
|---|---|---|
| | Example 5 | Example 6 |
| Binder weight | 0.700 | 0.700 |
| (—) relative to | | |
| carrier weight | | |
| Equivalent | 800 | 1100 |
| weight per one | | |
| mole of acid | | |
| functional | | |
| group of binder | | |
| (gmol⁻¹) | | |
| Additive | 1,3,5-triazine- | — |
| species | 2,4,6-triamine | |
| Additive weight | 0.150 | 0.000 |
| (—) relative to | | |
| carrier weight | | |
| Equivalent | 21.0 | — |
| weight per one | | |
| mole of basic | | |
| functional | | |
| group of | | |
| additive | | |
| (gmol⁻¹) | | |
| Base point | 8.16 | 0.000 |
| amount/Acid | | |
| point amount | | |
| (—) | | |
| Evaluation of | D | A |
| cracked area of | | |
| catalyst layer | | |

TABLE 8

| | Comparative | Comparative | Comparative | Comparative |
|---|---|---|---|---|
| | Example 7 | Example 8 | Example 9 | Example 10 |
| Binder weight | 0.850 | 1.00 | 1.15 | 0.850 |
| (—) relative to | | | | |
| carrier weight | | | | |
| Equivalent | 1100 | 1100 | 1100 | 1100 |
| weight per one | | | | |
| mole of acid | | | | |
| functional | | | | |
| group of binder | | | | |
| (gmol⁻¹) | | | | |
| Additive | — | — | — | — |
| species | | | | |
| Additive weight | 0.000 | 0.000 | 0.000 | 0.000 |
| (—) relative to | | | | |
| carrier weight | | | | |
| Equivalent | — | — | — | — |
| weight per one | | | | |
| mole of basic | | | | |
| functional | | | | |
| group of | | | | |
| additive | | | | |
| (gmol⁻¹) | | | | |
| Base point | 0.000 | 0.000 | 0.000 | 0.000 |
| amount/Acid | | | | |
| point amount | | | | |
| (—) | | | | |
| Evaluation of | A | A | A | A |
| cracked area of | | | | |
| catalyst layer | | | | |

TABLE 9

| | Comparative | Comparative | Comparative | Comparative |
|---|---|---|---|---|
| | Example 11 | Example 12 | Example 13 | Example 14 |
| Binder weight | 0.700 | 0.850 | 1.00 | 1.15 |
| (—) relative to | | | | |
| carrier weight | | | | |
| Equivalent | 600 | 600 | 600 | 600 |
| weight per one | | | | |
| mole of acid | | | | |
| functional | | | | |
| group of binder | | | | |
| (gmol⁻¹) | | | | |
| Additive | — | — | — | — |
| species | | | | |
| Additive weight | 0.000 | 0.000 | 0.000 | 0.000 |
| (—) relative to | | | | |
| carrier weight | | | | |
| Equivalent | — | — | — | — |
| weight per one | | | | |
| mole of basic | | | | |
| functional | | | | |
| group of | | | | |
| additive | | | | |
| (gmol⁻¹) | | | | |
| Base point | 0.000 | 0.000 | 0.000 | 0.000 |
| amount/Acid | | | | |
| point amount | | | | |
| (—) | | | | |
| Evaluation of | A | A | A | A |
| cracked area of | | | | |
| catalyst layer | | | | |

### Evaluation Results

As shown in Tables 1 to 9, it can be seen that in Examples 1 to 20, the crack area of the catalyst layer is smaller than that in Comparative Examples 1 to 14.

From the above results, it was demonstrated that when the ratio of the base point amount to the acid point amount is greater than 0 and equal to or less than 6.82, the occurrence of cracks in the catalyst layer can be suppressed when the organic nitrogen compound is included.

What is claimed is:

1. A catalyst comprising a metal particle having an oxygen reduction activity, an additive having a basic functional group, a binder having an acidic functional group, wherein:
the additive is at least one organic nitrogen compound; and
a ratio (base point amount/acid point amount) of a total base functional group amount of the additive to a total acid functional group amount of the binder is greater than zero and equal to or less than 6.82.

2. The catalyst according to claim 1, wherein the organic nitrogen compound is a monomer represented by Formula (1) described below, or a polymer that contains at least a part of the monomer 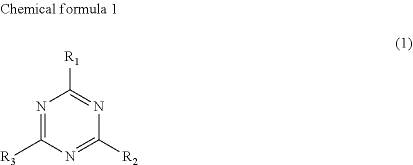
In Formula (1), R₁, R₂, R₃ are each a hydrogen atom, a halogen atom, or one kind of a functional group selected from a group of functional groups consisting of a nitrile group, an amido group, an imine group, an amino group, a thiol group, a hydroxyl group, a sulfo group, a carboxylic acid group, a phosphoric acid group, a ketone group, an aldehyde group, an ester group, an alkoxy group, a phenol group, a cyclopentyl group, a cyclohexyl group, an alkylamino group having 1 to 10 carbon atoms, an alkylsulfonic acid group having 1 to 10 carbon atoms, a perfluoroalkyl group having 1 to 10 carbon atoms, an alkyl group having 1 to 10 carbon atoms, an alkenylamino group having 1 to 10 carbon atoms, an alkenylsulfonic acid group having 1 to 10 carbon atoms, an perfluoroalkenyl group having 1 to 10 carbon atoms, and an alkenyl group having 1 to 10 carbon atoms, and the functional groups may each have, in a molecular chain, at least one kind selected from a group consisting of at least one kind of functional group selected from the group of functional groups, an aromatic ring, a heterocyclic ring, an oxygen atom, a sulfur atom, a nitrogen atom, a fluorine atom, a chlorine atom, a bromine atom, an iodine atom, and a hydrogen atom.

3. The catalyst according to claim 1, wherein the metal particle is at least one kind selected from a group consisting of a platinum particle, a platinum alloy particle, and a composite particle containing platinum.

4. The catalyst according to claim 1 further comprising a carrier, wherein the metal particle is supported by the carrier.

5. The catalyst according to claim 4, wherein a weight of the additive with respect to a weight of the carrier is equal to or more than 0.0100 and equal to or less than 0.150.

6. The catalyst according to claim 4, wherein a weight of the binder with respect to a weight of the carrier is equal to or more than 0.700 and equal to or less than 1.15.

7. The catalyst according to claim 1, wherein:
the binder is a perfluorocarbon sulfonate polymer; and
an equivalent weight per mole of the acidic functional group of the binder is equal to or more than 600 g/mol and equal to or less than 1100 g/mol.

8. The catalyst according to claim 1, wherein:
the additive is oleylamine, melamine, or a polymer of melamine; and
an equivalent weight of the additive per mole of the basic functional group is equal to or more than 21.0 g/mol and equal to or less than 267 g/mol.

9. An air electrode for a fuel cell or for a metal-air cell comprising the catalyst according to claim 1.

10. A fuel cell comprising the air electrode according to claim 9 as a cathode.

11. A metal-air cell comprising the air electrode according to claim 9 as a cathode.
